(19) United States
(12) Patent Application Publication
(10) Pub. No.: US 2006/0116162 A1
(43) Pub. Date: Jun. 1, 2006

(54) Methods for providing a subscriber service

(75) Inventors: Wealthy Desai, Atlanta, GA (US); Sandeep Betarbet, Lilburn, GA (US)

Correspondence Address: BELLSOUTH CORPORATION, P.O. BOX 2903, MINNEAPOLIS, MN, 55402-0903, US

(73) Assignee: BellSouth Intellectual Property Corporation

(21) Appl. No.: 10/999,325

(22) Filed: Nov. 30, 2004

(51) Int. Cl. H04M 1/00

(52) U.S. Cl. 455/556.2

(57) ABSTRACT

Methods provide a robust service to subscribers of an advertising program. Subscriber reports are delivered using electronic mail (e-mail), which eliminates the cost associated with printing and mailing the reports, while providing the ability to easily track the e-mailed reports. The reports can then be distributed to subscribers on a more frequent basis. The method also enables a customer service representative to remedy a problem associated with a subscriber based on the tracking of the e-mails including the reports. The methods tend to provide a more valuable service to the subscriber.

### FIELD OF THE INVENTION

The present invention generally relates to methods for providing a service. More particularly, the present invention relates to methods for providing quality service to a subscriber of an advertising program.

### BACKGROUND OF THE INVENTION

A Guaranteed Advertising Program (GAP) guarantees a certain number of calls to a subscriber if the subscriber advertises its goods/services using a particular vendor. The vendor providing GAP guarantees that the subscriber will receive a minimum number of calls each month by advertising using the vendor. If the subscriber does not receive the minimum number of calls, the vendor may compensate the subscriber, for example by issuing a rebate check. Typically, the vendor generates and mails a paper report to the subscriber every six months via regular U.S. mail. The report will generally include the number of calls received, if guarantees were fulfilled, and if the guarantees were not fulfilled, rebate calculations. The printing and mailing costs associated with the reports can be substantial. Also, the subscriber may be getting outdated information since the reports are typically only sent once or twice a year. Furthermore, there is no good way to determine whether the subscriber received the report and if the report was beneficial to the subscriber's needs. The current process of GAP reporting tends to be very costly for the vendor and does not provide a vital service to each subscriber.

Thus, there is a need for systems and methods which provide a better service to subscribers and reduced cost to vendors of an advertising program.

### SUMMARY OF THE INVENTION

Embodiments of the present invention address the above and other problems by providing services to subscribers of an advertising program. The methods described herein may be incorporated in a server, system, or a computer-readable medium. One embodiment of the invention includes retrieving a call report, the report including callback data associated with at least one call. The method operates to generate and send a target message to a subscriber, wherein the target message includes subscriber specific information and the call report.

Another embodiment of the invention includes querying a first database for a rejected message notification associated with a message not being received by at least one subscriber. The method also includes querying a second database for at least one target message associated with the at least one subscriber and correlating the target message and the rejected message. The method produces a correlated message file based on the correlation of the target and rejected messages.

Yet another embodiment of the invention provides a computer-readable medium containing computer-executable instructions which when executed by a computer perform a method for providing subscriber service to subscribers of an advertising program. The method includes retrieving a call report, the report including callback data associated with at least one call; generating a target message; sending a subscriber the target message, the target message including subscriber specific information and the call report; querying a first database for a rejected message notification associated with a message not being received by at least one subscriber; querying a second database for at least one target message associated with the at least one subscriber; correlating the target message and the rejected message; and producing a correlated message file based on the correlation of the target and rejected messages.

These and other features and advantages, which characterize the present invention, will be apparent from a reading of the following detailed description and a review of the associated drawings. It is to be understood that both the foregoing general description and the following detailed description are exemplary and explanatory only and are not restrictive of the invention as claimed.

### BRIEF DESCRIPTION OF THE DRAWINGS

FIG. 1 illustrates an exemplary computing system for embodiments of the present invention;

FIG. 2 is a simplified block diagram of a distributed computing environment for practicing embodiments of the present invention; and

FIG. 3 depict a process flow diagram according to an embodiment of the present invention.

### DETAILED DESCRIPTION

As briefly described above, embodiments of the present invention are directed to methods for providing a robust service to subscribers of an advertising program. According to embodiments of the present invention, a method involves delivering subscriber reports using electronic mail (e-mail), which eliminates the cost associated with printing and mailing the reports, while providing the ability to easily track the e-mailed reports. The method allows the provision of reports to subscribers on a more frequent basis, without the printing and postage costs. The method also enables a customer service representative to remedy a problem associated with a subscriber based on the tracking of e-mails including the reports. The method tends to provide a more valuable service to the subscriber. However, it will be appreciated that embodiments of the present invention are not limited to advertising programs, but may be utilized as a part of any system and method when it is desirable to maintain a robust customer service by tracking information related to a subscriber or customer, and using the results to better service the subscriber.

In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense and the scope of the present invention is defined by the appended claims and their equivalents.

Exemplary Computing Environment

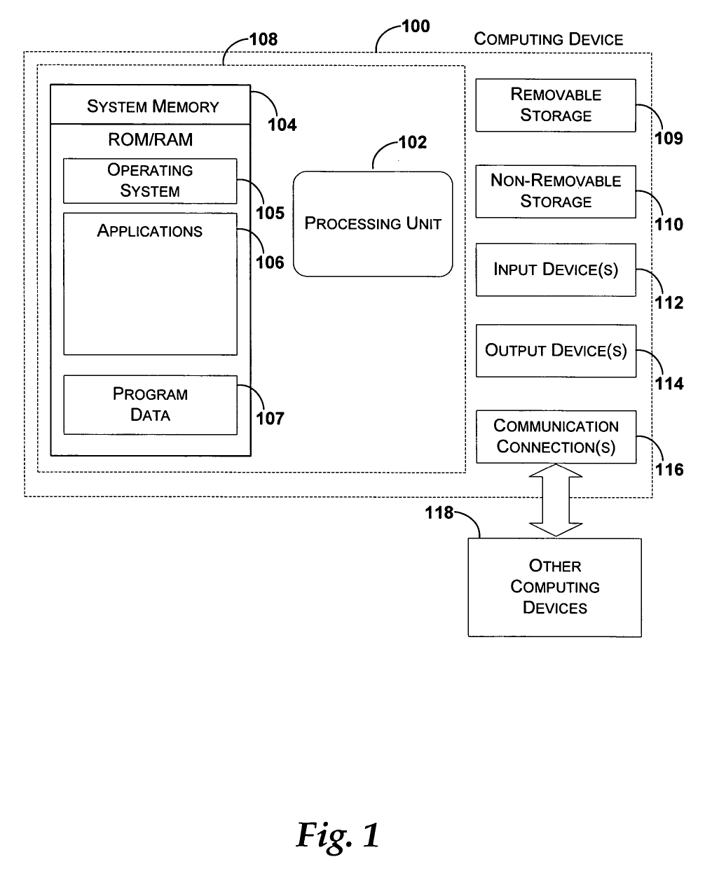

Referring now to the drawings, in which like numerals represent like elements through the several figures, aspects of the present invention and the exemplary operating environment will be described. FIG. 1 and the following discussion are intended to provide a brief, general description of a suitable computing environment in which the invention may be implemented. While the invention will be described in the general context of program modules that execute in conjunction with an application program that runs on an operating system on a personal computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

FIG. 1 depicts one exemplary system for implementing the invention includes a computing device, such as computing device 100. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more applications 106, and may include program data 107. This basic configuration is illustrated in FIG. 1 by those components within dashed line 108.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data.

System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included.

Computing device 100 may also contain communication connections 116 that allow the device to communicate with other computing devices 118, such as over a network. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Exemplary Operational Environment

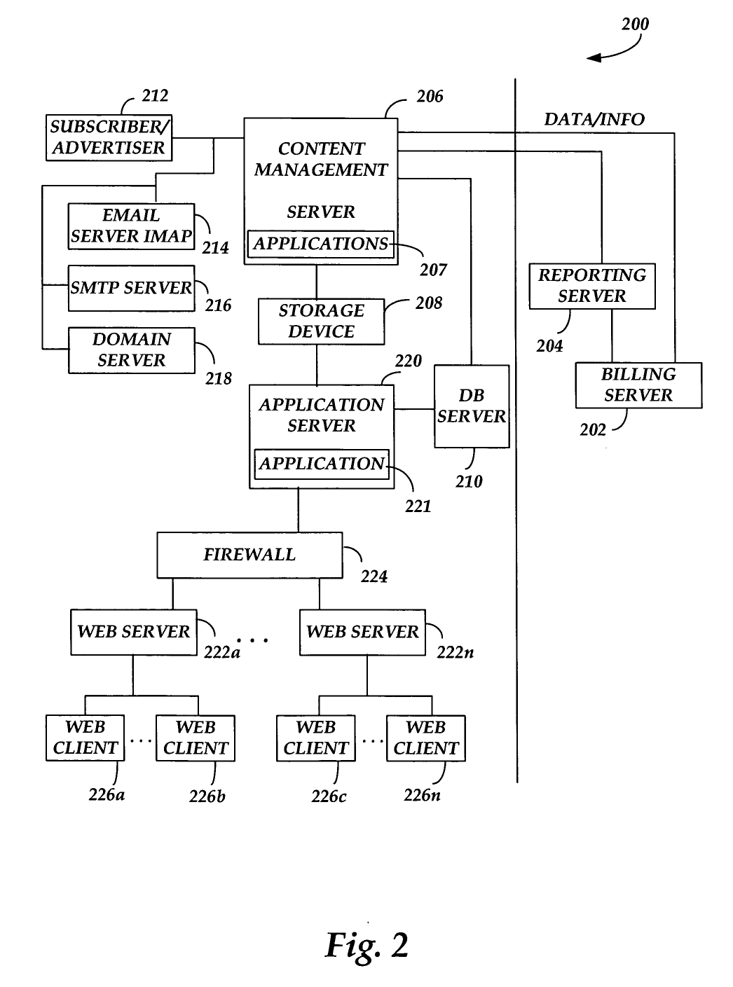

Referring now to FIG. 2, a simplified block diagram of an operational environment 200 for carrying out embodiments of the invention is shown. Embodiments of the invention provide methods for preparing, monitoring, and servicing reports associated with an advertising program, such as a GAP. Computer-readable media and associated computing systems can be used to provide the methods described herein. As shown in FIG. 2, a distributed computing environment includes a number of computing systems, which can include greater or fewer components than the exemplary computing system 100, described above.

The operational environment 200 includes a billing server 202 in communication with a reporting server 204 and a content management server 206. The content management server 206 is in communication with a storage device 208 which may be a storage server, a database server 210, an advertiser/subscriber 212, an Internet Message Access Protocol (IMAP) IMAP e-mail server 214, Simple Mail Transfer Protocol (SMTP) server 216, and a domain server 218. As described further below, the content management server 206 includes one or more applications 207 for performing certain tasks based on information received throughout the environment 200. An application server 220 is in communication with the storage device 208, database server 210, and one or more web servers 222a-222n through a firewall 224, where n is an integer number. One or more web client computers 226a-226n, where n is an integer, are in communication with the one or more web servers 222a-222n. As described below, a subscriber support representative of a particular vendor can use one of the web client computers 226a-226n to utilize an application on the application server 220 to determine how a subscriber should be serviced.

It will be appreciated the one or more of the servers, such as servers 206, 210, and 220, for example, depicted in FIG. 2 may be combined as a single computing system or expanded functionally as part of a larger system, and the invention is not intended to be limited to any specific embodiments or examples described herein. It will also be appreciated that a server is generally a computing system which provides one or more services/functions to other systems. For example, a server might have software running on it that allows it to act as a Web server, an e-mail server, and/or a file transfer protocol (FTP) server, among others. Clients, whether software and/or hardware enabled, generally access a particular server or servers with a specific intent.

As described above, it is preferred to provide feedback to a subscriber regarding an advertising program, such as a GAP, on a frequent basis, most preferably monthly. It is also preferable to track the status of feedback and provide additional service to a subscriber based on the status. According to embodiments of the invention, an e-mail message is generated and transmitted to a subscriber of an advertising program, including a subscriber specific report. The subscriber specific e-mails are tracked to ensure proper delivery to the subscriber. If an e-mail fails to reach a particular subscriber, the application 207 allows a subscriber service or other support representative who work those cases to call the subscriber, manually send out the report, or re-send the e-mail, etc.

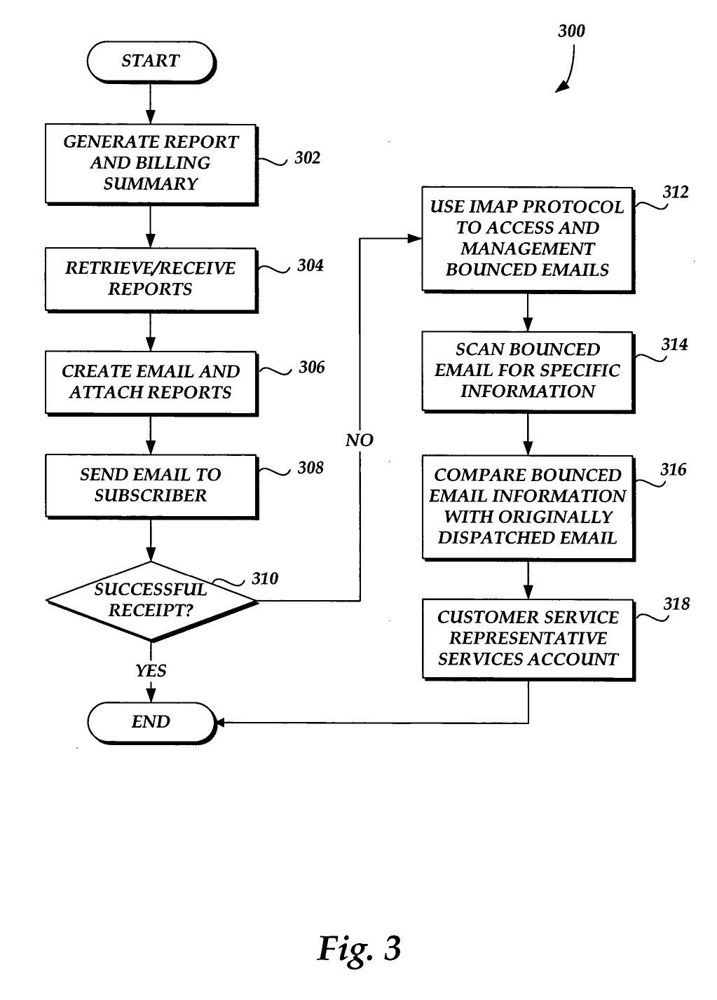

With additional reference to the flow diagram of FIG. 3, and continuing reference to FIG. 2, an exemplary method 300 of the present invention is described. At 302, the billing server 202 and reporting server 204 create a report associated with a particular subscriber of the service, such as an advertising service. The billing server 202 report may include the amount of advertising purchased, ad length, ad publication times, and the cost, for example. The reporting server 204 report may include a welcome letter for new subscribers, and other information on a monthly basis, quarterly basis, etc. indicating the number of calls generated and the rebate amount owed to the subscriber if the number of calls as promised are not met, etc. The reports/files are preferably formatted in .pdf before sending to the content management server 206. Other information, such as the subscriber's contact information, including a mailing address, phone number, and an e-mail address is also forwarded to the content management server 206 at 304. In alternative embodiments, the content management server 206 operates to retrieve reports/files and other information from the reporting server 204 and billing server 202 using an HTTP or other protocol. As described above, GAP is an advertising program which guarantees a certain amount of business to a subscriber if the subscriber uses a particular vendor for its advertising. According to embodiments of the invention, the vendor or a third party may implement the methods described herein.

At 306, after retrieving/receiving the reports/files via the reporting server 204 and billing server 202, an application 207, such as a JAVA script file, on the content management server 206 creates an e-mail addressed to the subscriber and attaches the reports/files associated with the subscriber to the e-mail. As described below, preferably the application 207 includes two main functions. One function operates to dispatch original (or target) e-mails while recording information into the database server 210, such as to whom the e-mail was sent, the date it was sent, and the content (report) part of the file that was attached to the e-mail. Additionally, subscriber information, such as the name of the subscriber, the subscriber ID, account ID, phone number, the directory in which an ad published, the ad, etc. are also stored in the DB server 210. The second function operates to capture a bounced e-mail, read it from the IMAP e-mail server 214, and to identify or compare the bounced e-mail with the original e-mail to uniquely identify the subscriber for presentation to a subscriber service representative.

As part of the first function, the application 207 generates a message within the e-mail body and subject, tailored to a particular subscriber, according to a rule set. The rule set can tailor the message, such as a welcome message, congratulatory message, detailed report message, or any other message tailored to the subscriber. The rule set may also determine the e-mail generating frequency based on the particular subscriber. The application 207 further operates to customize the content of the e-mail. For example, the application 207 can tailor the e-mail by inserting the subscriber name in the “To:” field. The application 207 may also alert the subscriber of the attached detailed report including what advertising medium(s) included the subscriber's listings, a specific number of calls received, or rebate. The application 207 is operable to change the content of the e-mail according to the particular subscriber. The application 207 then accesses the reports in .pdf from the storage device 208 and, at 308, the content management server 206 sends the e-mail and attachments to the subscriber. If the e-mail successfully reaches the subscriber as determined at 310, the process ends.

If the e-mail does not reach the subscriber, the application 207 utilizes the second function. The application 207 operates to remedy each situation based on one or more reasons why the e-mail did not reach the subscriber. As described further below, there are a number of reasons as to when an e-mail could not be delivered to the subscriber, i.e. “bounced e-mail.” For example, the e-mail address may have been incorrect, a network error occurred, the domain name may have been incorrect, or any other reason that the e-mail failed to deliver. For these situations and others, the e-mail will bounce back and return to the IMAP e-mail server 214, which can be an Exchange server, for example. However, the IMAP e-mail server 214 can be any e-mail compatible server which includes an IMAP interface.

As described above, IMAP stands for Internet Message Access Protocol. IMAP enables users to interface with and access e-mail messages that are kept on a mail server, which can be a shared server. In other words, IMAP permits a “client” program to access remote message stores as if they were local. For example, email stored on an IMAP server, such as IMAP e-mail server 214, can be manipulated from a desktop computer at home, a workstation at the office, and a notebook computer while traveling, etc. without the need to transfer messages or files back and forth between these computers. IMAP provides the ability to access and manage e-mail messages (both new and saved) from more than one computer.

When the IMAP e-mail server 214 receives a bounced message, the application 207 includes IMAP operability for accessing and managing bounced e-mails residing on the IMAP e-mail server 214. When a bounced e-mail message comes into the IMAP e-mail server 214, the IMAP e-mail server 214 directs the bounced e-mail to a folder. The folder may be associated with the particular e-mail address or other criteria. Furthermore, each e-mail address is typically owned by one particular entity. The application 207, using IMAP, may define one default mailbox and multiple other mailboxes which include multiple folders. When an e-mail bounces, it is sent to a particular folder, of a particular mailbox, an INBOX folder for example. At 312, the application 207, using an IMAP client and an authentication sequence, uses an IMAP protocol to access, retrieve, and/or manage messages from the particular folder.

IMAP provides the ability to “manipulate remote folders other than INBOX” for both online and disconnected operation. This means being able to save messages from one folder to a different one, being able to access archived messages subsequently, and allowing for multiple incoming message folders. Accessing “multiple incoming message folders” is useful for people who have partitioned their incoming mail streams, either via delivery filters, or by having different accounts for different purposes. The same protocol issues that argue for the online or disconnected access model for one's INBOX also apply to other message folders. Note that, depending on the IMAP client implementation and the mail architecture desired by a system manager, the user may save messages locally, or save them on a server, or both.

According to one embodiment of the invention, the application 207, using an IMAP client, polls the IMAP e-mail server 214 on a periodic or continuous basis. The application 207 may poll one or more mailboxes, querying to determine if there are any new bounced messages to be accessed and/or managed from a particular mailbox folder. Alternatively, the application 207 may poll one or more mailboxes and respective folders at a scheduled time/day, requesting bounced e-mails which are present in one or mailbox folders.

In the continuous monitoring mode, the application 207, continuously monitors the IMAP e-mail server 214 asking whether there are any bounced e-mails. The reply may include the most recent bounced e-mails which are passed to the application 207. More particularly, once the application 207 has accessed and read the bounced e-mails from the IMAP e-mail server 214, the status of the e-mails immediately changes. That is, the e-mails become stale. So the next time the application 207 polls the IMAP e-mail server 214 asking for the latest e-mails, the server 214 will not provide e-mails read previously. Only recently bounced e-mails will be available in a particular mailbox folder. In this mode, the application 207 continuously polls the IMAP e-mail server 214 and accesses only the most recent e-mails. The application 207 can also delete e-mails from the IMAP e-mail server 214 or it can change an e-mail's status back to unread, etc. The application 207 has complete control over all e-mails on the IMAP e-mail server 214 in the mailboxes and folders which are owned by a particular client.

A bounced e-mail includes important information utilized by the application 207 to provide various remedies, described below. For example, the bounced e-mail may include a specific subject line which reads “undeliverable.” According to one preferred embodiment, at 314 the application 207 reviews recently bounced e-mails in a particular mailbox for specific information, such as an “undeliverable” subject line, for example. The application 207 may also review the body sections of recently bounced e-mails for error text associated with a particular error message. For example, the application 207 may be configured to look for bounced e-mails including an “undeliverable” subject line. Once located, these e-mails are scanned by the application 207 for details to determine exactly why a particular message bounced.

As described above, the application 207 is operable to recognize bounced e-mails. The application 207 is further operable to associate a bounced e-mail with the originally dispatched e-mail message. The body of the bounced e-mail includes a reproduced date that the original e-mail was sent and the address to which the original e-mail was sent. The application 207 uses these dates and addresses to manage the bounced e-mails and determine particular subscribers associated with the bounced e-mails.

Referring again to FIG. 2, when the application 207 originally creates and dispatches an e-mail to a subscriber, it also records the dispatched report, to whom it was dispatched, and the dispatch date. This information is stored by the application 207 in the database server 210. As described above, each bounced e-mail, stored on the IMAP e-mail server 214, also includes this information in the body of the message. The application 207 communicates with the database server 210 and IMAP e-mail server 214 using information associated with the bounced e-mail, including the original e-mail address and dispatch date-time (includes time of day down to 1-second), to compare with the information stored on the database server 210. The application 207 creates a new entry in an account e-mail database in database server 210, recording the date-time on which the bounced e-mail was received and records the point or reference to the original e-mail which was dispatched and to whom it was dispatched and the reason for the delivery failure. Thus, to reiterate, the application 207 operates to read three items from a bounced e-mail: 1) the date-time the original e-mail was sent; 2) the original intended recipient; and 3) the reason for the delivery failure. The application 207 then stores these items in the database server 210.

There are multiple reasons why e-mails may bounce. For example, an e-mail address typically includes a username followed by the @ symbol followed by a domain name. In one scenario, the domain name might be correct but when the e-mail actually reaches the main host where the user is supposed to exist it bounces because the user no longer exists. The e-mail will bounce back with an error message and the information described above to a location in the IMAP e-mail server 214. As another example, there are situations when the domain name of the e-mail address is incorrect. An SMTP e-mail server 216 is typically a shared resource which is also used to dispatch e-mails. If the SMTP server 216 does not recognize the domain name, the e-mail bounces back to the IMAP e-mail server 214.

A third scenario for a bounced e-mail occurs when the SMTP server 216 actually dispatches an e-mail but the final destination where the e-mail is directed has issues. For example, the dispatched e-mail may be directed to a mailbox having a message limit and the dispatched e-mail exceeds this limit. Again, the e-mail will bounce back to the IMAP e-mail server 214. Or, the mailbox may have a limit on the size of incoming e-mail messages. If an e-mail exceeds this limit, the e-mail will bounce back to the IMAP e-mail server 214. As an example, suppose a message is sent having an attachment of two megabytes in size, and it reaches a mailbox which has a size limit of one megabyte. Even though the e-mail address is correct, the e-mail will bounce back to the IMAP e-mail server 214. This scenario is somewhat different in that the original report that was dispatched may not be returned. However, the bounced e-mail will include the reason for the failure, the original date when it was sent and to whom it was sent.

A fourth scenario, although somewhat rare, occurs when there is a failure somewhere in between the original mail transmission and the intended final destination. It is well known that e-mail systems typically utilize a store and forward mechanism. That is, an e-mail is generally stored and forwarded between several computers or hosts in transit to the final destination. Sometimes one of the computers can drop the e-mail for failing to validate a domain name using the domain name server 218, for example. The domain name server 218, based on the e-mail domain name, can tell the mail host where to forward the e-mail. If the information is incorrect or outdated, then the e-mail bounces back to the IMAP e-mail server 214.

For each of these scenarios, and others, embodiments of the invention operate to track the e-mail and make certain that each subscriber has received its associated e-mail and reports. If an e-mail bounces, the application 207 provides information, based on the comparison of the bounced and original e-mail information at 316, enabling a subscriber service representative to service a particular account. A subscriber service representative uses one of the web clients 226a-226n to access one of the web servers 222a-222n to thereby utilize the application 221 on the application server 220. At 318, the subscriber service representative uses the application 221 to read information related to the bounced and original e-mails from the DB server 210. Based on the information stored on the DB server 210, the subscriber service representative attempts to recognize the reason why one or more e-mails bounced. According to the analysis, the subscriber service representative can correct identified errors and resend the e-mail with attachments, or call the subscriber to obtain new subscriber information, such as an updated e-mail address, etc.

The subscriber service representative may be located anywhere as long as they can access the application 221 running on the application server 220. The application 221 is operable to organize the collected bounced and original e-mail information from the DB server 210 and present it to one or more subscriber service representatives via web servers 222a-222n at one or more of the web clients 226a-226n. The presented information, herein termed a delivery reject report, includes, among other information, the reason the e-mail failed, who it was sent to, the subscriber's name, subscriber's e-mail address, subscriber's business address, and/or phone number. The delivery reject report is a correlated informational resource including the information contained in the original e-mail and the bounced e-mail, presented in a single format.

A subscriber service representative can review the delivery reject report and determine how to provide the best remedy according to the information contained in the delivery reject report. For example, if upon reviewing the delivery reject report, the subscriber service representative determines that the e-mail address is valid and the e-mail bounced because of a network error, then the subscriber service representative may just re-send the original e-mail. If the subscriber service representative determines that the e-mail address is incorrect, the subscriber service representative can call the subscriber using the information in the report to find out the proper e-mail address and correct the e-mail address in stored in the system 200. The application 221 is further operable to read the bounced e-mail database and the original e-mail database and present the correlated information in a file or directly to a display 114 which allows a subscriber service representative to determine the best remedial course of action.

In alternative embodiments, the subscriber service representative can be a program running on one or more of the web clients 226a-226n or web servers 222a-222n, thereby providing an automated process with little or no human interaction. The application 221 can also e-mail the delivery reject report and other information directly to a subscriber service representative, automatically alerting the subscriber service representative that there is a problem. The e-mail may include all of the subscriber information, and the bounced e-mail, the intended report, and the original e-mail. However, it will be appreciated that the present invention is not limited to advertising programs, but may be utilized as a part of any system and method when it is desirable to maintain a robust customer service by tracking information related to a subscriber or customer, and using the results to better service the subscriber.

It will be apparent to those skilled in the art that various modifications or variations may be made in the present invention without departing from the scope or spirit of the invention. Other embodiments of the invention will be apparent to those skilled in the art from consideration of the specification and practice of the invention disclosed herein.

We claim:

1. A computer-readable medium containing computer-executable instructions which when executed by a computer perform a method for providing call feedback, the method comprising:
retrieving a report, the report including data associated with at least one call,
generating a report message, each report message associated with at least one rule, and
sending a user the report message, the report message containing user specific information and the report.

2. The computer-readable medium of claim 1, the method further comprising generating the report message to include a tailored notification, the tailored notification corresponding to the at least one rule.

3. The computer-readable medium of claim 1, the method further comprising generating the report message to include a call detail report and/or billing information.

4. The computer-readable medium of claim 1, the method further comprising retrieving the report including data associated with an advertising program.

5. The computer-readable medium of claim 1, the method further comprising retrieving the report including data associated with a number of calls received by an advertiser as part of a guaranteed advertising program.

6. The computer-readable medium of claim 1, the method further comprising sending the user the report message using an electronic mail (e-mail) protocol.

7. The computer-readable medium of claim 6, the method further comprising sending the user the report message on a periodic basis.

8. A computer-readable medium containing computer-executable instructions which when executed by a computer perform a method for tracking messages associated with a subscriber, the method comprising:
querying a first source for a rejected message notification associated with a message not being received by at least one subscriber,
querying a second source for at least one target message associated with the at least one subscriber,
correlating the target message and the rejected message, and
producing a correlated message file based on the correlation of the target and rejected messages.

9. The computer-readable medium of claim 8, the method further comprising querying the second source for at least one of a sent date-time, addressee, attachment, and/or message content of the target message in the first source.

10. The computer-readable medium of claim 8, the method further comprising querying the first source for at least one of a receive date-time, addressee, and a delivery failure notification associated with the rejected message.

11. The computer-readable medium of claim 8, the method further comprising reviewing the rejected message using Internet Message Access Protocol (IMAP).

12. The computer-readable medium of claim 8, the method further comprising reviewing content of the rejected message for a date-time on which the target message was sent, contents sent with the target message, and/or a delivery address to which the target message was sent.

13. The computer-readable medium of claim 8, the method further comprising providing an authenticating signal to IMAP before querying the first source for the rejected message.

14. The computer-readable medium of claim 8, the method further comprising querying the first source on a periodic or continuous basis.

15. The computer-readable medium of claim 8, the method further comprising receiving at least one of a network error notification that an e-mail message was not received by a subscriber of an advertising program, a domain name error notification that an e-mail message was not received by a subscriber of an advertising program, a user name error notification that an e-mail message was not received by a subscriber of an advertising program, and/or an invalid address error notification that an e-mail message was not received by a subscriber of an advertising program.

16. The computer-readable medium of claim 8, the method further comprising using the correlated message file to provide a subscriber service to the at least one subscriber.

17. A method for providing subscriber service to subscribers of an advertising program, the method comprising:
retrieving a call report, the report including callback data associated with at least one call,
generating a target message,
sending a subscriber the target message, the target message including subscriber specific information and the call report,
querying a first database for a rejected message notification associated with a message not being received by at least one subscriber,
querying a second database for at least one target message associated with the at least one subscriber,
correlating the target message and the rejected message, and
producing a correlated message file based on the correlation of the target and rejected messages.

18. The method of claim 17, further comprising using the correlated message file to provide a subscriber service to the at least one subscriber.

19. The method of claim 17, further comprising sending the correlated message file as part of an e-mail to a subscriber service representative.

20. The method of claim 17, further comprising providing the correlated message file to a web interface for access by at least one subscriber service representative.
